(19) United States
(12) Patent Application Publication
(10) Pub. No.: US 2003/0180420 A1
(43) Pub. Date: Sep. 25, 2003

(54) Dough and container combination and method for making same

(76) Inventors: Philippe Herbez, Noyelles Sous Lens (FR); Pascal Palavit, Bully Les Mines (FR); Philippe Drouet, Paris (FR)

Correspondence Address: FINNEGAN, HENDERSON, FARABOW, GARRETT & DUNNER, LLP, 1300 I STREET, NW, WASHINGTON, DC, 20005, US

(21) Appl. No.: 10/221,495

(22) PCT Filed: Mar. 13, 2001
(86) PCT No.: PCT/FR01/00738

(30) Foreign Application Priority Data
Mar. 13, 2000 (FR) 00/03168

(51) Int. Cl. A23B 4/00

(52) U.S. Cl. 426/128

(57) ABSTRACT

The invention concerns a dough and closed container system, said closed container system allowing only gas outflow and the paste comprising, as essential constituents, flour, water, baking powder, baker's yeast, low temperature inactive yeast and alcohol. Sid combination is such that the essential constituents are selected in ratios such that the internal pressure of the container during the time interval included between Day 3 and Day 50 after being prepared ranges between about 6 psi (41.4 kPa) and about 30 psi (2068 kPa) at a temperature ranging between 0° C. and 12° C.

The present invention relates to a combination of a dough and a closed container system preferably in the form of a box, as well as to a process for manufacturing it.

The field of the present invention is that of ready-to-use doughs intended to be sold as “fresh products”, which are stored in refrigerated areas.

A study of the prior art revealed the existence of a number of documents relating to such doughs, and in particular doughs packaged in boxes.

U.S. Pat. No. 5,084,284 describes in particular the use of a tubular box for packaging a dough based on chemical leavening agent, this box having the advantage of being solid enough so as not to be damaged when it is placed under vacuum. This patent moreover describes a method for working a dough comprising, in particular, a step of placing this dough under vacuum. This method advantageously makes it possible to avoid having to prove said dough before it is placed in a box.

Doughs intended to be placed in such boxes comprise chemical powders also known as baking powder or chemical raising agent as leavening agents. Now, it is known that doughs based on chemical raising agent do not have entirely satisfactory organoleptic properties (taste, texture).

The problem posed by the present invention was to prepare a dough comprising a baker's yeast and which can be packaged in a closed container system, preferably in a box.

For the purposes of the present description, the term “baker's yeast” denotes a microorganism, as opposed to “chemical raising agent” or “baking powder” which refer to purely chemical products.

The presence of dry or hydrated baker's yeast in doughs gives them a particular aroma and taste which consumers perceive as a product of quality.

The term “hydrated” yeast means commercial yeasts. The term “dry” yeast means a dehydrated yeast which can be converted into hydrated yeast when an amount of water equal to twice its weight is added thereto.

Dough-based products generally have the particular feature of needing to undergo a step known as “proving of the dough” before being placed in their packaging.

Proving generally consists in placing the dough at room temperature for a given period of time so as to allow the raising agents to react. This step is characterized by an expansion in the volume of the dough generally of between 1 and 15% relative to the initial volume of the dough. This proving step allows a dough which has been stored for a few days, or even a few weeks, to develop in order to give a product which has the texture, density and taste of bakery products.

The problem posed by doughs containing baker's yeasts is that said yeast generally continues to grow and to produce carbon dioxide until the dough is cooked. Even at refrigeration temperatures, i.e. between about 0° C. and about 12° C., such baker's yeasts remain active and continue to produce carbon dioxide. The use of such a yeast consequently requires control of the raising of dough based on baker's yeast in order to avoid any rupture or explosion of the container in which said dough is placed. It has been demonstrated that the activity of a baker's yeast when it is contained in a dough maintained between 0° C. and 12° C. is low during the first days following the preparation of the dough, but that it generally develops from the 7th day (D+7) after preparation.

Manufacturers of doughs intended to be stored in containers have logically been led to replace the baker's yeasts in their products with baking powders such as sodium bicarbonate and the like. The products generally used are a combination of raising acid (citric acid and glucono-delta-lactone (GDL)) and a raising base, for example bicarbonate of soda.

A skilful combination of these raising agents makes it possible to generate carbon dioxide in the dough, thus producing an increase in the volume of this dough. The main advantage of these chemical raising agents is that their behavior is predictable. Specifically, it suffices to calculate the proportions of each of the reagents in order to know what volume of carbon dioxide will be released.

According to one variant, it is also possible to use only one of the components of the chemical raising agent: the acidic component or the basic component; this component will then react with a compound of the medium which may act respectively, as a base or as an acid.

When baking powders are used to prepare dough-based products, it is observed that the production of carbon dioxide begins relatively soon after the dough is placed in a box and that this production of carbon dioxide is constant (throughout the duration of the chemical reaction) and then ceases (when the agent in default has been entirely consumed).

The use of such chemical raising agents makes it possible to prepare a dough which has a satisfactory shelf life for a fresh product without posing the problems associated with the increase in the internal volume of the wrapping which are encountered when a baker's yeast is used. Nevertheless, the use of these baking powders does not make it possible to achieve organoleptic properties equivalent to those of a dough made with baker's yeast.

The problem posed by the present invention was to manufacture a bakery product such as a bread roll, a brioche loaf, a croissant, a pain au chocolat, a brioche or a pizza dough which contains baker's yeast and which can be sold in a closed container system and in particular in a box.

Now, a person responsible for producing such doughs knows that the main problem posed by baker's yeasts is that they release an amount of carbon dioxide (CO₂) which is very much greater than the amount of CO₂ generated when a baking powder is used, and that this production of gas takes place practically throughout the duration of storage of said dough. A person skilled in the art consequently knows that it is difficult to package such a product in a closed container system.

The authors of the present invention have demonstrated that the use of a combination of baker's yeast, chemical raising agent and alcohol makes it possible to prepare a dough which satisfies the requirements set both by the technology chosen (closed container system) and by the consumer. Indeed, this dough has organoleptic qualities that are comparable with those of a dough prepared using a baker's yeast as sole raising agent.

Moreover, the development of this dough in a closed container system such as a box should be such that the box can be opened by the consumer without any special effort: (i.e. spontaneous opening when the consumer tears the wrapping) without, however, said box exploding spontaneously during storage (at the site of manufacture, at its point of sale, etc.) or during its transportation.

The present invention relates to a combination of a dough and a closed container system, said closed container system exclusively allowing the exit of gases and the dough comprising, as essential constituents, flour, water, chemical raising agent, low-temperature-inactive (LTI.) baker's yeast and alcohol, the essential constituents being chosen in ratios such that the internal pressure of the box in the period between D+3 and D+50 is between about 6 psi (41.4 kPa) and about 30 psi (206.8 kPa) at a temperature of between 0° C. and 12° C.

For the purposes of the present invention, the expression “D+3 and D+50” means, respectively, 3 days and 50 days after preparing the “dough+wrapping” system, i.e., respectively, 3 days and 50 days after preparing the dough and its packaging.

For the purposes of the present invention, the term “LTI.” yeast means any low-temperature-inactive baker's yeast which can be used for preparing bakery items intended for cooking just before consumption, after having been stored for a few days at refrigeration temperatures. These baker's yeasts have the property of being virtually inactive at the usual refrigeration temperatures, i.e. at temperatures of between 0 and 12° C., of surviving at these temperatures and of then regaining their activity at higher temperatures, in particular at and above 13 or 14° C. The LTI. yeasts sold by the company Lesaffre are suitable, for example, for preparing the dough used in the present invention.

The chemical raising agent used in the present invention is preferably chosen from the group of conventional chemical raising agents comprising bicarbonate of soda, disodium dihydrogen diphosphate (SAPP), glucono-delta-lactone and mixtures thereof. Bicarbonate of soda can also be used in encapsulated form. The role of the chemical raising agent in the present invention is to allow the dough to be raised during the first days after it is placed in a box (“starter” role). Thus, from D+3 onwards, the dough is pressing against the wall of the wrapping, thus making the wrapping easy to open from D+3 onwards, and also making it possible to chase out the residual air contained in the wrapping, since this air would have the consequence of oxidizing the dough.

The dough used in the present invention is prepared in a conventional manner by mixing its various constituents together and then rolling out the dough thus formed into strips.

The wrapping system used for storing the dough before it is consumed should satisfy the following criteria: it should only allow the exit of any gases released by the dough and should be impermeable to both the exit and the entry of any liquid, oily or solid products. In addition, this wrapping should be easy to open, and similarly it should be easy to remove the dough from its wrapping without damaging it. The materials used to form this wrapping should also be strong enough for a constant internal pressure to be maintained throughout the duration of storage of the product (at the site of manufacture, at its point of sale, etc.) or during its transportation. The materials conventionally used are cardboard materials optionally reinforced with any agent known for increasing the hardness of materials of this type, and/or optionally covered with a sheet of another material: aluminum, polymer, etc.

The box used in the present invention is preferably a cylindrical box, the cylindrical wall will preferably be formed by rolling up a spiral-shaped strip of cardboard, and the top and bottom of said box will be formed from discs crimped to the cylindrical wall.

The cylindrical part of this box is preferably manufactured from a spiral-shaped piece of cardboard, which is rolled up on itself to form the cylindrical body of the box and the pitches of which are connected side by side by means of an adhesive material which is strong enough to prevent the box thus formed from rupturing. The adhesive used to join together the pitches of the spiral-shaped piece should, however, be made of a material which does not withstand a pressure exerted by a user who wishes to open the box. The inner wall of the cylindrical box is preferably lined with a film of an inert polymer, and a film of aluminum can be placed between the cardboard wall and the polymer film. Any polymer which has the property of being inert and non-toxic with respect to the dough product with which it will be in contact can be used.

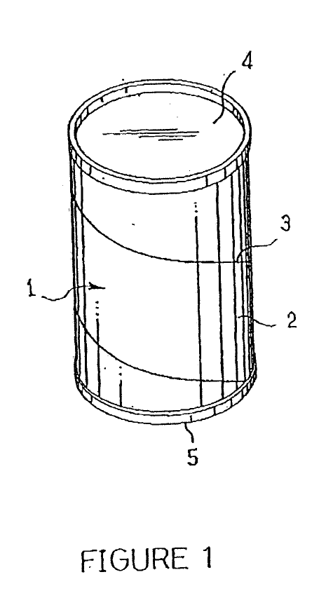

FIG. 1 is a schematic representation of the box used in the present invention; the box (1) is obtained by rolling up a spiral-shaped strip (2) whose pitches are attached side by side (3). The top (4) and bottom (5) of the box are discs crimped to the cylindrical body of the box.

The dough used in the combination according to the present invention containing flour, water, chemical raising agent, LTI. baker's yeast and alcohol will preferably have a weight percentage of chemical raising agent relative to the dough of between 0.01 and 2.5 when a conventional chemical raising agent or a mixture of conventional raising agents are used. The term “conventional chemical raising agent” is understood to mean a non-encapsulated chemical raising agent. When bicarbonate of soda in encapsulated form is used as chemical raising agent, it is necessary to provide between one and nine times as much bicarbonate of soda as the amount envisaged if the bicarbonate of soda was used in free form, (conventional). In general, the encapsulated bicarbonate of soda is used in an amount such that the weight percentage of encapsulated bicarbonate of soda relative to the dough is between 0.30 and 0.60; by way of example, it will be possible to use encapsulated bicarbonate CAP-SHURE® SB 140-70A sold by the company Balchem Corporation.

Preferably, the LTI. baker's yeast used is dry yeast, preferably, the weight percentage of dry LTI. baker's yeast relative to the dough is between 0.08 and 0.2.

The alcohol used to prepare the dough is preferably ethanol. Advantageously, the weight percentage of ethanol relative to the dough is between 1.65 and 2.

The dough used according to the present invention can be either a dough intended to be converted into a sweet product or into a salty product. Consequently, the dough may contain at least one agent chosen from the group consisting of sugars, sweeteners, flavor enhancers, agents for maintaining the cooked dough in its expanded form, fats, flavorings, preserving agents, coloring agents, salt, egg and gluten.

Thus the combination according to the present invention is intended for doughs for the preparation of a bread roll, a brioche loaf, a croissant, a pain au chocolat, a brioche or a pizza dough.

Advantageously, the dough used in the combination according to the present invention comprises:

0.14% by weight of dry baker's yeast,

0.06% by weight of bicarbonate of soda or 0.51% of encapsulated bicarbonate of soda and 0.95% of glucono-delta-lactone,

from 1.70 to 1.90% by weight of pure ethanol.

The doughs obtained by the implementation of the present invention can generally be kept for 50 days. In order to consume a product which has optimum organoleptic qualities, it is advisable to consume it within 35 days.

The present invention also relates to a process for preparing a combination of a dough and a box, which comprises the following steps:

a) mixing together the flour, water, baker's yeast, chemical raising agent and alcohol;

b) isolating a mass of the dough obtained;

c) rolling out said dough;

d) rolling up said dough to form a cylinder;

e) introducing this cylinder into the box and closing said box;

f) leaving the dough to stand at a temperature of between about 20° C. and about 30° C. for 3 to 10 hours, so as to allow said dough to prove;

g) cooling the dough to about 2° C. for 3 days.

It can also be envisaged to add other ingredients into step a), such as sugars, sweeteners, flavor enhancers, agents for maintaining the cooked dough in its expanded form, fats, flavorings, preserving agents, coloring agents, salt, egg or gluten.

A subject of the present invention is also the variants of this process which also comprise at least one additional step known to those skilled in the art, such as a step of rolling and folding the dough used by intercalating several layers of dough with several layers of fat.

The examples which follow illustrate the invention without limiting its scope.

Each of the products of Examples 1 to 8 was prepared according to the procedure below:

1000 g of dough were obtained by mixing together, in a kneading mixer sold by the company Hobart, the ingredients presented in Examples 1 to 8.

240 g of the dough thus obtained were then rolled out and then rolled up to form a cylinder which was placed in a cylindrical box.

The “box+dough” combinations were stored overnight at room temperature (20° C.) to allow said dough to prove.

The pressure inside the box was measured one day after placing the dough in the box (D+1) and the “box+dough” combinations were then stored for 14 days at 9° C.

The pressures inside the composite boxes were measured at D+1 and at D+14. This pressure measurement was carried out by comparing, using a strain gauge, the pressure exerted on the top of the boxes studied at D+1 and then at D+14, to the pressure exerted on the top of an empty box.

### EXAMPLE 1

1000 g of dough were prepared from water, flour (400 g), dry LTI. yeast (1.4 g) and bicarbonate of soda (2.5 g) as component of chemical raising agent.

### EXAMPLE 2

A dough was prepared in accordance with that given in Example 1, using a mixture of bicarbonate of soda (2.5 g) and SAPP (3.5 g) as chemical raising agent.

### EXAMPLE 3

A dough was prepared in accordance with that given in Example 1, using glucono-delta-lactone (6.8 g) as component of chemical raising agent.

### EXAMPLE 4

A dough was prepared in accordance with that given in Example 1, using a mixture of bicarbonate of soda (10 g) and SAPP (14 g) as chemical raising agent.

### EXAMPLE 5

A dough was prepared in accordance with that given in Example 1, using a mixture of bicarbonate of soda (0.4 g) and SAPP (0.6 g) as chemical raising agent.

### EXAMPLE 6

A dough was prepared in accordance with that given in Example 1, using bicarbonate of soda (0.4 g) as component of chemical raising agent.

### EXAMPLE 7

A dough was prepared in accordance with that given in Example 1, using a mixture of bicarbonate of soda (0.4 g) and glucono-delta-lactone (6.8 g) as chemical raising agent.

### EXAMPLE 8

A dough was prepared in accordance with that given in Example 1, using a mixture of encapsulated bicarbonate of soda (5 g) and glucono-delta-lactone (9.3 g) as chemical raising agent.

The results of the pressures of the boxes at D+1 and D+14 are given in Table I.

TABLE 1

| Example | Pressure at D + 1 | | Pressure at D + 14 | |
|---|---|---|---|---|
| 1 | 2.19 | psi | 13.64 | psi |
| 2 | 2.03 | psi | 16.09 | psi |
| 3 | 2.45 | psi | 11.71 | psi |
| 4 | 13.64 | psi | 23.80 | psi |
| 5 | 2.67 | psi | 19.04 | psi |
| 6 | 0 | psi | 4.82 | psi |
| 7 | 5.72 | psi | 13.67 | psi |
| 8 | 5.12 | psi | 18.57 | psi |

From this table, it can be seen that certain boxes have too low an internal pressure; this is the case, for example, for the box of Example 6. In contrast, the internal pressure of box 4 was found to be too high, since the risks of explosion of this box before 40 days were considered to be too high.

The results obtained with boxes 1, 2, 3 and 5 were found to be quite good, although the pressure at (D+1) is relatively low.

Consequently, it was decided to select the boxes of Examples 7 and 8 on the grounds that the change in internal pressure was in accordance with expectations. Furthermore, for the case in which the pressure inside one of these boxes became too high, the use of an LTI. yeast inhibitor, such as, for example, an alcohol, could also be envisaged to control the increase in pressure inside the box.

Examples 7 and 8 were repeated, adding ethanol in the following weight proportions relative to the dough: 1.63; 1.72; 1.91 and 2.1.

It was thus shown that if the percentage of ethanol used was less than 1.70, the box exploded within 40 days, whereas the use of ethanol in a weight percentage of greater than 1.90 led to the inhibition of the yeast.

A complementary study was carried out in order to compare the “acceptability”, by a panel of consumers, of the cooked dough product with a comparative product based on chemical raising agent without baker's yeast.

It emerges from this comparative study that a dough packaged in a composite box in accordance with the present invention finds significantly more favor than a comparative product based on chemical raising agent (without baker's yeast) packaged in a composite box, this comparison being carried out on cooked doughs.

On the basis of these tests, 4 types of croissants were manufactured. The ingredients of Examples 9 to 12 were mixed together successively in an industrial mixer.

### EXAMPLE 9 (FIG. 2)

The term “soda” means “bicarbonate of soda”

| | | |
|---|---|---|
| Flour | 250 | kg |
| Gluten | 20 | kg |
| Sugar | 18.75 | kg |
| Dextrose | 6.25 | kg |
| Ascorbic acid | 0.025 | kg |
| Water | 162.00 | kg |
| 95% strength alcohol | 12.50 | kg |
| Encapsulated soda* CAPSHURE ® | 3.13 | kg |
| SB140-70A | | |
| G.D.L. 5.85 | kg | |
| Dry LTI. yeast | 0.875 | kg |
| Salt | 5.00 | kg |
| Emulsifier | 0.88 | kg |
| Leavne flavoring | 3.75 | kg |
| Total before rolling and folding | 489.01 | kg |
| Anhydrous butter | 139.75 | kg |
| Total | 628.76 | kg |

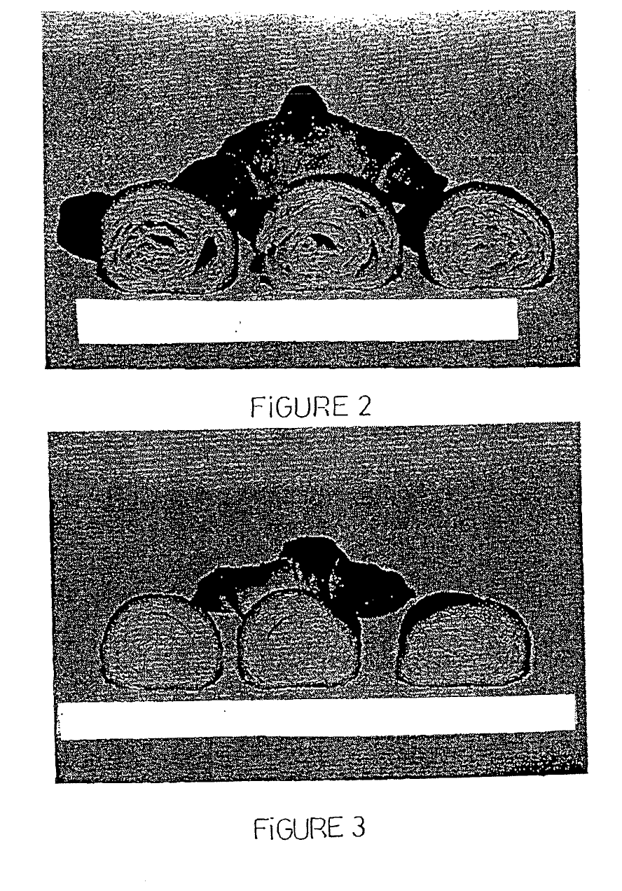

### EXAMPLE 10 (FIG. 3)

| | | |
|---|---|---|
| Flour | 250 | kg |
| Gluten | 20 | kg |
| Sugar | 12.50 | kg |
| Dextrose | 13.75 | kg |
| Buttermilk | 1.25 | kg |
| Ascorbic acid | 0.025 | kg |
| Water | 177.50 | kg |
| 95% strength alcohol | 7.50 | kg |
| Standard soda | 6.50 | kg |
| SAPP | 9.20 | kg |
| Salt | 3.80 | kg |
| Total before rolling and folding | 502.025 | kg |
| Anhydrous butter (rolling and | 139.75 | kg |
| folding) | | |
| Total | 641.775 | kg |

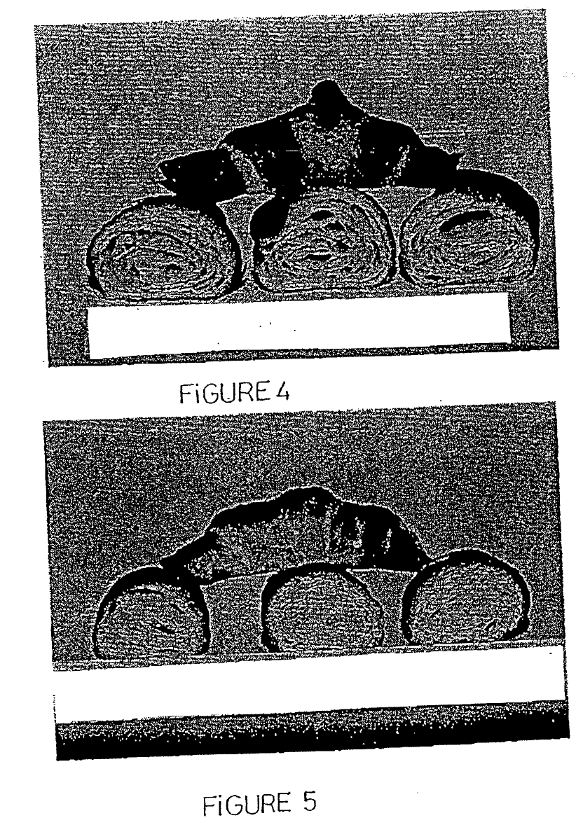

### EXAMPLE 11 (FIG. 4)

| | | |
|---|---|---|
| Flour | 250 | kg |
| Gluten | 20 | kg |
| Sugar | 18.75 | kg |
| Dextrose | 6.25 | kg |
| Ascorbic acid | 0.025 | kg |
| Water | 162.00 | kg |
| 95% strength alcohol | 12.50 | kg |
| CAPSHURE ® SB 140-70A soda | 3.13 | kg |
| G.D.L. | 5.85 | kg |
| Dry LTI. yeast | 0.875 | kg |
| Salt | 5.00 | kg |
| Emulsifier | 0.88 | kg |
| Leaven flavoring | 3.75 | kg |
| Total before rolling and folding | 489.01 | kg |
| Anhydrous vegetable fat (rolling | 139.75 | kg |
| and folding) | | |
| Total | 628.76 | kg |

### EXAMPLE 12 (FIG. 5)

| | | |
|---|---|---|
| Flour | 250 | kg |
| Gluten | 20 | kg |
| Sugar | 7.50 | kg |
| Dextrose | 12.50 | kg |
| Ascorbic acid | 0.025 | kg |
| Water | 177.50 | kg |
| 95% strength alcohol | 5.00 | kg |
| Standard soda | 6.50 | kg |
| SAPP | 9.20 | kg |
| Salt | 2.05 | kg |
| Total before rolling and folding | 490.275 | kg |
| Margarine for rolling and folding | 139.75 | kg |
| Total | 630.025 | kg |

The doughs thus obtained are extruded to give a continuous band which is then cut into two portions, between which has been continuously placed the fat: anhydrous butter for Examples 9 and 10, vegetable fat for Example 11 and margarine for Example 12. This “dough-fat-dough” mixture is rolled out by successive passages through a series of rolls, and then folded up to form a thicker doughstick. This operation is repeated 2 to 3 times in order finally to obtain a so-called “rolled and folded” rolled-out dough 3 to 4 millimetres thick containing between 20 and 30 layers of fat.

The dough is then cut into strips, which are themselves cut into triangles, and these strips are rolled up to form a dough roll which is placed in the composite box.

The boxes are then capped, after which they are placed in a proving chamber (25° C.) for 10 hours, this step allowing the dough to rise (evacuation of the residual air in the boxes).

The products are then stored in a cold chamber for 3 days.

The croissants represented in FIGS. 2 to 5 are respectively obtained by mixing together the ingredients of Examples 9 to 12.

These figures illustrate that the croissants containing baker's yeast (LTI.)+chemical raising agent have a less compact texture than those which exclusively contain chemical raising agent. In addition, the croissants containing L.T.I. yeast+chemical raising agent find greater favor than the croissants containing only chemical raising agent since these have a markedly more salty taste.

“Brioche dough+composite box” combinations according to the invention were also produced.

Examples 13 and 14 show the ingredients for preparing a butter brioche and an ordinary brioche (containing anhydrous vegetable fat), respectively.

The doughs thus obtained are either shaped into balls or extruded to obtain a continuous strip which is then cut into 2 parts which are placed one on top of the other, flattened by successive treatment in a series of rollers, and finally folded to form a thicker dough roll.

This operation is repeated twice to obtain a uniform strip of dough, from which are cut circles of dough slightly smaller in diameter than that of the composite box in which they will be stored. A given number of dough slice units are then stacked in the composite box.

The boxes are then covered with a lid and then placed in a “proving chamber” (25° C.) for 10 hours, this step allowing the dough to rise (removal of the residual air in the box).

The products are then stored in a cold chamber.

### EXAMPLE 13

| | |
|---|---|
| Flour | 250.00 |
| Gluten | 10.00 |
| Sugar | 25.00 |
| Water | 112.50 |
| Anhydrous butter | 52.50 |
| Egg | 50.00 |
| 95% strength alcohol | 10.30 |
| Dry LTI. yeast | 0.760 |
| Salt | 6.25 |
| Encapsulated soda | 1.95 |
| CAPSHURE ® SB 140-70A | |
| G. D.L. | 3.70 |
| Dextrose | 17.50 |
| Total (kg) | 540.96 |

### EXAMPLE 14

| | |
|---|---|
| Flour | 250.00 |
| Gluten | 10.00 |
| Sugar | 25.00 |
| Water | 112.50 |
| Anhydrous vegetable fat | 52.50 |
| Egg | 50.00 |
| 95% strength alcohol | 10.80 |
| Dry LTI. yeast | 0.760 |
| Salt | 6.25 |
| Encapsulated soda | 1.95 |
| CAPSHURE ® SB 140-70A | |
| G.D.L. | 3.70 |
| Dextrose | 17.50 |
| Total (kg) | 540.96 |

1. A combination of a dough and a closed container system, said closed container system exclusively allowing the exit of gases and the dough comprising, as essential constituents, flour, water, chemical raising agent, LTI. baker's yeast and alcohol, characterized in that the essential constituents are chosen in ratios such that the internal pressure of the box in the period between D+3 and D+50 is between about 6 psi (41.4 kPa) and about 30 psi (206.8 kPa) at a temperature of between 0° C. and 12° C.

2. The combination as claimed in claim 1, such that the dough comprises chemical raising agent chosen from the group comprising bicarbonate of soda, disodium dihydrogen diphosphate (SAPP), glucono-delta-lactone and mixtures thereof.

3. The combination as claimed in the preceding claim, such that the weight percentage of the chemical raising agent relative to the dough is between 0.01 and 2.5, when a conventional chemical raising agent or a mixture of conventional chemical raising agents are used.

4. The combination as claimed in claim 1, such that the chemical raising agent used is encapsulated bicarbonate of soda and the weight percentage of encapsulated bicarbonate of soda relative to the dough is between 0.30 and 0.60.

5. The combination as claimed in one of the preceding claims, such that the LTI. baker's yeast employed is dry yeast, the weight percentage of the dry LTI. baker's yeast relative to the dough is between 0.08 and 0.2.

6. The combination as claimed in one of the preceding claims, such that the alcohol used is ethanol, in a weight percentage relative to the dough of between 1.65 and 2.

7. The combination as claimed in one of the preceding claims, such that the dough contains at least one agent chosen from the group consisting of sugars, sweeteners, flavor enhancers, agents for maintaining the cooked dough in its expanded form, fats, flavorings, preserving agents, coloring agents, salt, egg and gluten.

8. The combination as claimed in one of the preceding claims, such that the dough comprises:
0.14% by weight of dry baker's yeast,
0.06% by weight of bicarbonate of soda or 0.51% of encapsulated bicarbonate of soda and 0.95% of glucono-delta-lactone,
from 1.70 to 1.90% by weight of pure ethanol.

9. The combination as claimed in one of the preceding claims such that the dough is a dough for bread rolls, brioche loaves, croissants, pains au chocolat, brioches or pizza dough.

10. A process for preparing a combination of a dough and a box, characterized in that it comprises the following steps:
a) mixing together the flour, water, baker's yeast, chemical raising agent and alcohol;
b) isolating a mass of dough obtained;
c) rolling out said dough;
d) rolling up said dough to form a cylinder;
e) introducing this cylinder into the box and closing said box;
f) leaving the dough to stand at a temperature of between about 20° C. and about 30° C. for 3 to 10 hours so as to allow said dough to prove;
g) cooling the dough to about 2° C. for 3 days.
